(19) United States
(12) Patent Application Publication
(10) Pub. No.: US 2006/0054696 A1
(43) Pub. Date: Mar. 16, 2006

(54) Low-profile stacked media card connector

(76) Inventor: Aruong Juang, Taoyuan Hsien (TW)

Correspondence Address: HARRINGTON & SMITH, LLP, 4 RESEARCH DRIVE, SHELTON, CT, 06484-6212, US

(21) Appl. No.: 10/522,511

(22) PCT Filed: Jul. 31, 2003
(86) PCT No.: PCT/SG03/00184

§ 371 Date: Oct. 31, 2005

(30) Foreign Application Priority Data
Jul. 31, 2002 (TW) 091117140

(51) Int. Cl. G06K 7/06

(52) U.S. Cl. 235/441

(57) ABSTRACT

Disclosed is a low-profile stacked media card connector (110), having: a housing (120) defining a first storage area (130) for receiving a first card-like media and a second storage area (140) for receiving a second card-like media, the second storage area (140) being stacked above the first storage area (130); a first connecting means (132) being arranged substantially between the first storage area (130) and the second storage area (140); and a second connecting means (142) for connecting the second card-like media, the second connecting means (142) being provided on the housing (120).

### FIELD OF INVENTION

This invention relates to a low-profile stacked media card connector for receiving two media cards, particularly to a stacked media card connector having a low profile.

### BACKGROUND OF INVENTION

Single stacked media card connectors formed by stacking connectors for receiving two of media cards are currently available on the market. Some of the stacked media card connectors may receive two PCMCIA cards simultaneously, while the others may receive one PCMCIA card and a non-PCMCIA card, such as a smart card, SD card, or an MMC card.

For such stacked media card connectors, a connecting means that is compatible with the specific media card(s) is electrically connected to the card(s) serving as a communication interface between the media card(s) and the computer.

FIG. 1 illustrates a perspective view of a prior stacked media card connector. As shown in FIG. 1, the prior stacked media card connector 10 comprises: a housing 20 defining a first storage area 30 and a second storage area 40, the second storage area 40 being stacked above the first storage area 30, wherein the first storage area 30 and the second storage area 40 are separated by a shield 50.

The prior connector 10 further comprises: a first connecting means 32 for electrically connecting a first card-like media, such as a smart card, the first connecting means being arranged at an outer face of the first storage area 30, and a second connecting means (not shown) for electrically connecting the second card-like media, such as a PCMCIA card, the second connecting means being provided at an end of the housing 20.

As shown in FIG. 1, though the prior stacked media card connector 10 may receive two media cards at the same time, because such a stacked media card connector for receiving a smart card and a PCMCIA card is constructed by stacking a conventional smart connector over a conventional PCMCIA card connector, a covering 60 must be provide at an outer side thereof for mounting of the first connecting means 32. The covering 60 and the first connecting means 32 jointly increase the overall thickness of the stacked media card connector 10.

In addition, because the first connecting means 32 is provided at an outer side of the conventional PCMCIA card connector, the first storage area 30 must be stacked above the second storage area 40, but not vice versa, when mounting such a stacked media card connector for receiving a smart card and a PCMCIA card to a motherboard, so as to reduce the flexibility in the design of the assembled product.

To meet the consumers' demands for further reduction of the weight and size of computer products, the thickness of a portable computer is a major concern for the consumers in selecting a portable computer.

To further reduce the thickness of the portable computer, the computer manufacturers have been striving to reduce the sizes of various components, even by a difference of 0.2 to 3 mm, in order to reduce the overall thickness of the portable computers.

### SUMMARY OF INVENTION

It is thus a primary objective of this invention to provide a stacked media card connector for receiving two media cards, by reducing its thickness to obtain a low-profile stacked media card connector.

It is another objective of this invention to use a connecting means compatible to a specific media card to be part of a shield between two storage spaces for receiving the two media cards.

It is a further objective of this invention to provide a stacked media card connector that may be mounted in a regular or an upside-down orientation, to improve flexibility in mounting and designing the assembled product.

To achieve the above objectives, this invention discloses a low-profile stacked media card connector, comprising: a housing defining a first storage area for receiving a first card-like media and a second storage area for receiving a second card-like media, the second storage area being stacked above the first storage area; a first connecting means for connecting the first card-like media, the first connecting means being arranged substantially between the first storage area and the second storage area; and a second connecting means for connecting the second card-like media, the second connecting means being provided on the housing.

The structures and characteristics of this invention can be realized by referring to the appended drawings and explanations of the preferred embodiments.

### BRIEF DESCRIPTION OF DRAWINGS

FIG. 1 is an exploded perspective of a prior stacked media card connector.

FIG. 2 is a perspective view of a low-profile stacked media card connector according to this invention.

FIG. 3 is an exploded perspective view of FIG. 2.

FIG. 4 is a plan view of FIG. 4.

FIG. 5 is a cross-sectional view taken along lines 5-5 of FIG. 4.

### DETAILED DESCRIPTIONS OF EMBODIMENTS

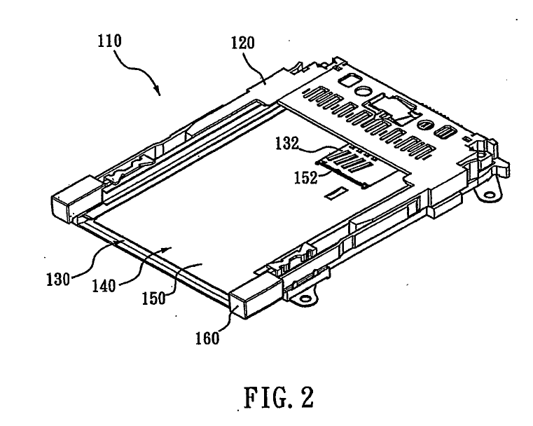

FIGS. 2, 3 and 4 respectively illustrate a perspective view, an exploded perspective view and a plan view of a low-profile stacked media card connector 110 for receiving two media cards according to this invention.

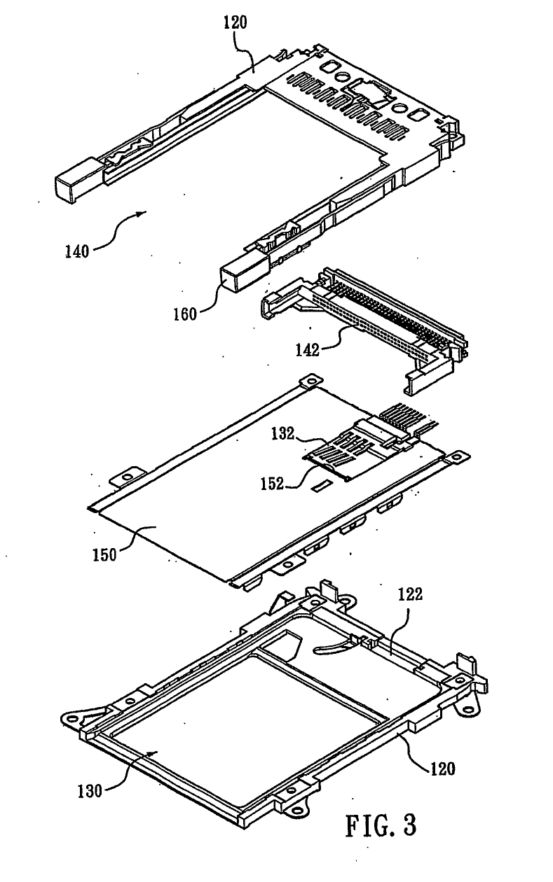

As shown in FIGS. 2 and 3, the low-profile stacked media card connector 110 according to this invention comprises: a housing 120 defining a first storage area 130 for receiving a first card-like media, such as a smart card, and a second storage area 140 for receiving a second card-like media, such as a PCMCIA card. The second storage area 140 is stacked above the first storage area 130. The first storage area 130 and the second storage area 140 are separated by a shield 150 for shielding from noises. The shield 150 may be made from a malleable metal sheet.

The connector 110 further comprises: a first connecting means 132 for electrically connecting the first card-like media, and a second connecting means 142 for connecting the second card-like media, the second connecting means being 142 provided on the housing 120. To be compatible with a smart card, the first connecting means 132 may be a smart card connecting module; to be compatible with a PCMCIA card, the second connecting means 142 may be a PCMCIA connecting module.

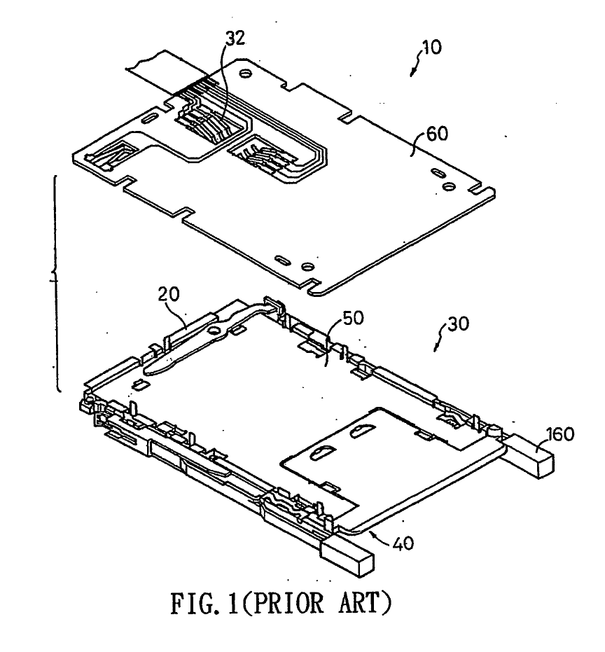

The connector 110 may further be provided with a conventional card ejecting mechanism 160 for ejecting the PCMCICA card received in the second storage area 140, if desired. The ejecting means 160 may be that illustrated in FIG. 1 or any other conventional designs.

To reduce the overall thickness of the stacked media card connector 110 to meet the market demands, the first connecting means 132 is arranged substantially between the first storage area 130 and the second storage area 140.

With reference with FIG. 3, to facilitate mounting of the first connecting means 132 between the first storage area 130 and the second storage area 140, the housing 120 is formed with a recess 122 for receiving at least a half thickness of the first connecting means 132. The shield 150 is also formed with an opening 152 for receiving another half thickness of the first connecting means 132, such that the first connecting means 132 serves as part of shield 150 between the first and second storage spaces 130, 140 for separating the two storage spaces. Because the connecting means 132 is also made of a metallic material, it can serve to shield noises while inhibiting bending and deformation of the card-like media inserted into the first storage area 130 and allowing smooth insertion, ejection and access to the first card-like media.

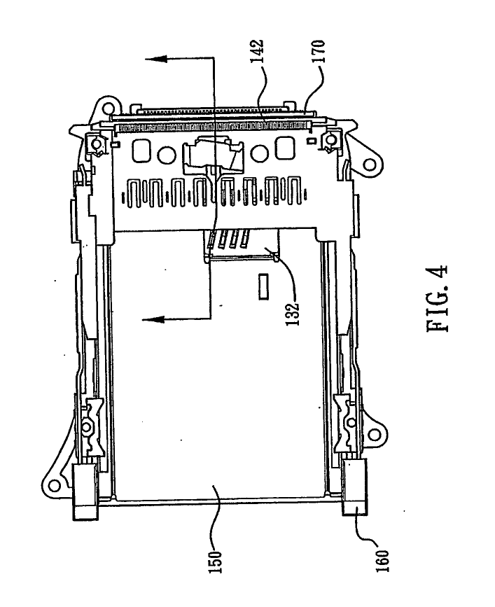

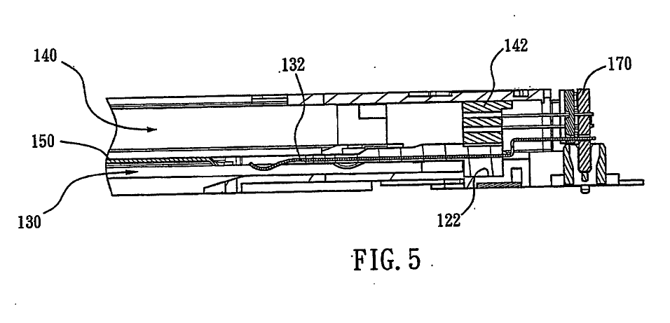

With reference to FIGS. 4 and 5, when mounting such a low-profile stacked media card connector to a motherboard of a portable computer, the first connecting means 132 and the second connecting means 142 are connected to a common transmission board 170 connected to the motherboard, to serve as a communication interface between the two card-like media and the computer.

According to this invention, because the first connection means 13 is arranged substantially between the first storage area 130 and the second storage area 140, the overall thickness of the connector 110 is reduced by at least 2.1 mm as compared to the connector illustrated in FIG. 1, without effecting the functions of the low-profile stacked media card connector 110 and the portable computer with a significant reduction of the overall thickness of the portable computer.

According to this invention, under a state that is permissible by the circuitry of the computer motherboard, such as that while no circuitry is etched to the motherboard at the location onto which the connector is mounted, the covering 60 shown in FIG. 1 that was previously provided at an outer side of the first connecting means 132 may be eliminated to further reduce the overall thickness.

Furthermore, because the first connecting means 132 is provided between the first storage area 130 and the second storage area 140, in mounting such a stacked media card connector to a computer motherboard, the connector may be mounted in a conventional manner, similar to that shown in FIG. 1, in which the first storage area 13 is stacked above the second storage area 140 for receiving the PCMCIA card, or in a manner shown in FIG. 5, in which the second storage area 140 for storing the PCMCIA card is stacked over the first storage area 130, to improve flexibility in mounting and designing the assembled product.

This invention is related to a novel creation that makes a breakthrough in the art. Aforementioned explanations, however, are directed to the description of preferred embodiments according to this invention. Various changes and implementations can be made by persons skilled in the art without departing from the technical concept of this invention. Since this invention is not limited to the specific details described in connection with the preferred embodiments, changes to certain features of the preferred embodiments without altering the overall basic function of the invention are contemplated within the scope of the appended claims.

LISTING OF NOMENCLATURES

| Prior Art | | Present invention | |
|---|---|---|---|
| 10 | connector | 110 | connector |
| 20 | housing | 120 | housing |
| 30 | first storage area | 122 | recess |
| 32 | first connecting means | 130 | first storage area |
| 40 | second storage area | 132 | first connecting means |
| 50 | shield | 140 | second storage area |
| 60 | covering | 142 | second connecting means |
| | | 150 | shield |
| | | 152 | opening |
| | | 160 | ejecting means |

What is claimed is:

1. A low-profile stacked media card connector, comprising:
a housing defining a first storage area for receiving a first card-like media and a second storage area for receiving a second card-like media, the second storage area being stacked above the first storage area;
a first connecting means for connecting the first card-like media, the first connecting means being arranged substantially between the first storage area and the second storage area; and
a second connecting means for connecting the second card-like media, the second connecting means being provided on the housing.

2. The low-profile stacked media card connector of claim 1, wherein the housing is formed with a recess for receiving at least half thickness of the first connecting means.

3. The low-profile stacked media card connector of claim 1, further comprising a shield separating the first and second storage areas.

4. The low-profile stacked media card connector of claim 3, wherein the shield is formed with an opening for receiving at least half thickness of the first connecting means.

5. The low-profile stacked media card connector of claim 1, wherein the first card-like media is a smart card and the first connecting means is a smart card connecting module.

6. The low-profile stacked media card connector of claim 1, wherein the second card-like media is a memory card.

7. The low-profile stacked media card connector of claim 1, wherein the first and second connecting means are connected to a common transmission board connected to a PCB.
